(19) United States
(12) Patent Application Publication
(10) Pub. No.: US 2017/0231848 A1
(43) Pub. Date: Aug. 17, 2017

(54) MEDICAL ISOLATION TRANSPORT SYSTEM-MITS

(71) Applicant: Air Shelters USA, LLC, Hatboro, PA (US)

(72) Inventor: Willem VanBasten, Hatboro, PA (US)

(21) Appl. No.: 15/345,401

(22) Filed: Nov. 7, 2016

Related U.S. Application Data
(60) Provisional application No. 62/251,355, filed on Nov. 5, 2015.

(51) Int. Cl. A61G 10/00; A61G 10/02; A61G 3/00

(52) U.S. Cl. CPC A61G 10/005; A61G 3/008; A61G 10/023

(57) ABSTRACT

A flexible rapid deployable system that may be used create an isolated space within a medical transport vehicle for use when transporting infected or contaminated patients, including a flexible tent-like liner creates a room inside the vehicle where both the patient and medical personnel can be isolated and contain contaminants within and a filtration system capable of producing the required air flow to maintain a negative pressurized isolated environment, sized to effectively accomplish this for the isolated cubic space.

### FIELD OF THE INVENTION

The present invention relates to medical isolation systems.

### BACKGROUND OF THE INVENTION

Current available mobile personal isolation systems only isolate the patient on a stretcher, bed or exam table. This system only allows access to the patient via integrated gloves and thus makes taking care of the patient difficult. This is especially the case when life support equipment needs to be used or other invasive procedures need to be performed. In hospitals, patients are placed in Isolation Rooms. This is a specially equipped room that is negative pressurized with the use of medical hepa filtration systems that scrub and evacuate the air. When an infected or contaminated patients requires transport and medical care, a medic will accompany the patient in personal protective gear. The transport vehicle, however, will become contaminated possibly posing a serious health risk to others and requiring extensive decontamination of the vehicle.

### SUMMARY OF THE INVENTION

The present invention was developed to answer the growing need for isolating infected and/or contaminated patients that require transportation via ambulance. The medical isolation transport system (“MITS”) of the present invention is a flexible rapid deployable system that may be used create an isolated space within a medical transport vehicle for use when transporting infected or contaminated patients. The MITS is essentially a rapid and easily deployed liner system for use in the transport vehicle. A flexible tent-like liner creates a room inside the vehicle where both the patient and medical personnel can be isolated and contain contaminants within. The system may be connected to a portable medical hepa filtration system to create a negative pressure environment so that contaminants remain inside the room. Air flows thru the filtration system where it is essentially be “scrubbed” of contaminants. The air discharged from the hepa system is then exhausted outside the vehicle. Clean ambient air flows into the room via adjustable vents. The in-flow or “make-up” air is restricted as compared to the outflow via the hepa scrubber, thus creating a slight negative pressure environment. It is essential that the room remains deployed and not collapse on itself as it is negative pressurized. The MITS accomplishes this by an integrated air structure that is inflated and forms the interior shape of the vehicle. The MITS will be sized to fit specific transport vehicles such as ambulance or bus.

### DESCRIPTION OF THE DRAWINGS

The subsequent description of the preferred embodiments of the present invention refers to the attached drawings, wherein:

FIG. 1 is a perspective view of a flexible tent-like liner with inflatable support tubes, inflation, and air circulation/filtration systems, according to an embodiment of the invention

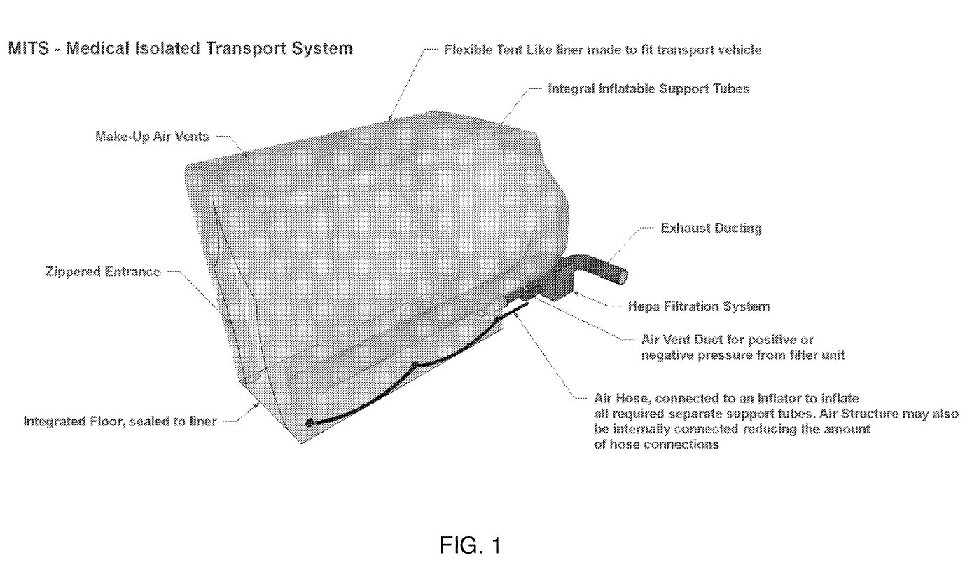

FIG. 2 is a rear view of an embodiment of the MITS of the invention deployed inside of a standard ambulance/rescue squad vehicle.

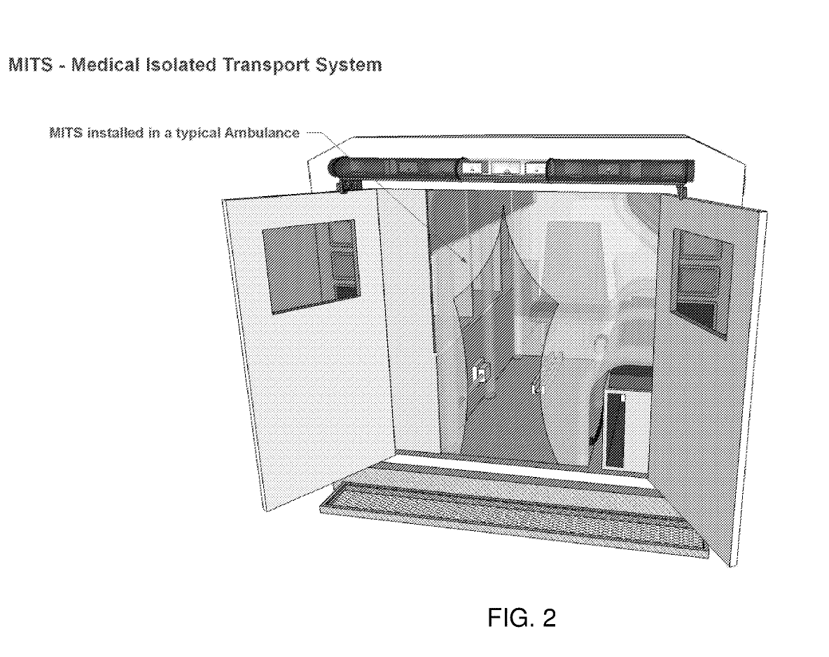

FIG. 3 is a perspective view of an embodiment of the MITS of the invention deployed inside of a standard ambulance/rescue squad vehicle.

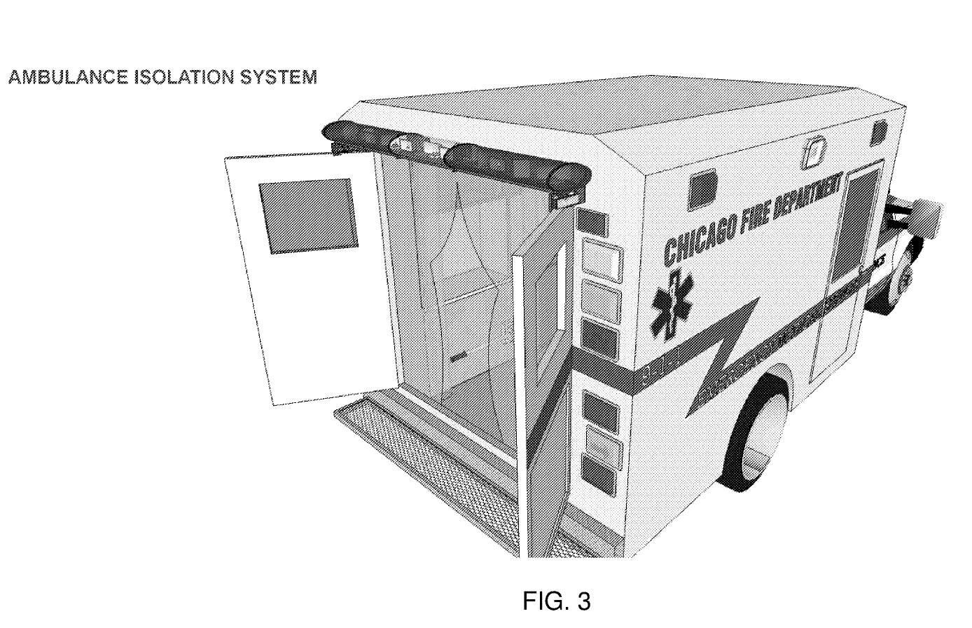

FIG. 4 is a rear view of another embodiment of the MITS of the invention deployed inside of a standard ambulance/rescue squad vehicle.

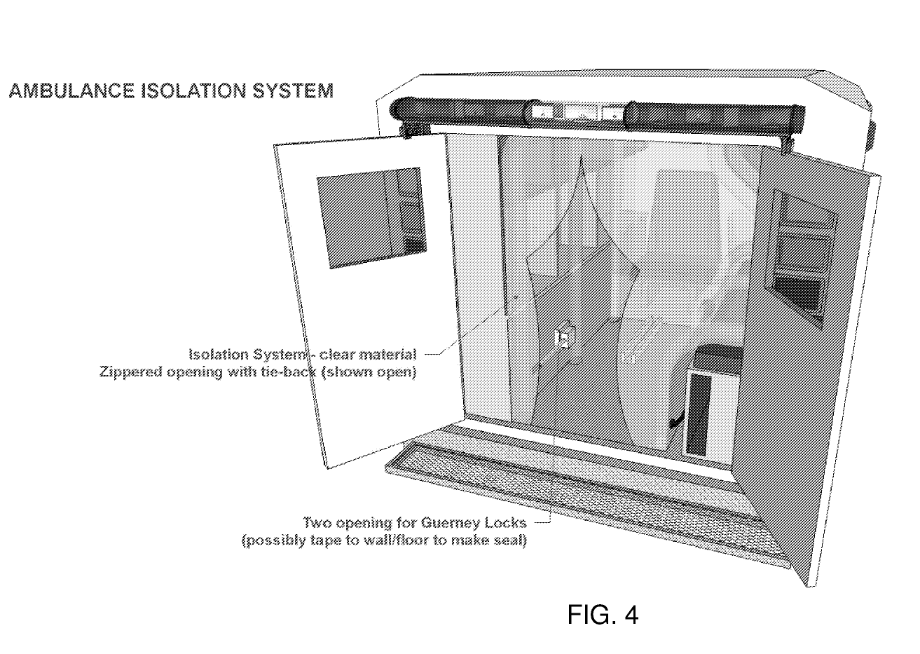

FIG. 5 is cut-away cross-section view of an embodiment of the MITS of the invention deployed inside of a standard ambulance/rescue squad vehicle.

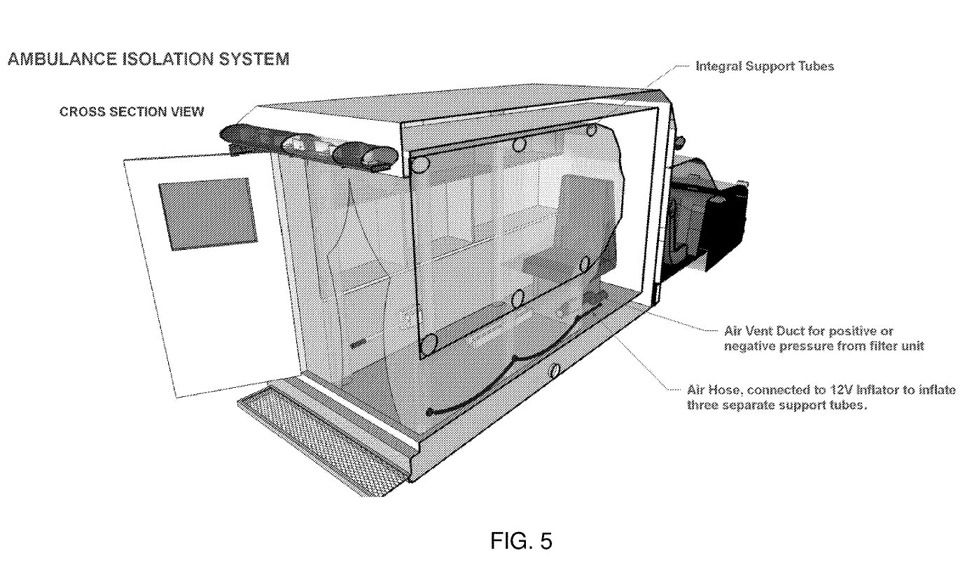

### DETAILED DESCRIPTION OF THE INVENTION

Referring to the figures, an exemplary MITS according to the invention may have the following components:
Flexible tent like liner made to fit into and create a treatment-space enclosure inside an emergency vehicle;
A separate or integrated structure system to maintain the tented space
At least one zippered entrance
A filtration system capable of producing the required air flow to maintain a negative pressurized isolated environment, sized to effectively accomplish this for the isolated cubic space.

The MITS is a flexible cost effective system to create an isolated space within a medical transport vehicle. The system is easily deployed and installed within minutes with the vehicle. The liner allows for a stretcher to be placed and locked for safe transport. The system will allow for Medical personnel to be with the patient in a controlled environment. The isolated environment ensures safety to others as well as protecting the vehicle form contamination, which reduces the need for costly and time consuming decontamination. The system will make it possible to transport contaminated patients and contain the hazards associated with doing so. The MITS is compact and lightweight when stored. Most if not all of the liner system will be made with clear materials, allowing light form the vehicle to illuminate the isolated environment. Make-Up Air vent(s) will be placed near the vehicle HVAC ducts so heated or cooled air can flow from the vehicle into the isolated tent like negative pressure environment. The integrated and sealed floor will be capable of containing bodily or other spilled fluids. The mechanical systems consisting of the filtration system and, in the case of the preferred embodiment, an inflator system to erect the tubular structure will be reusable. The tent like isolated environment will be deemed disposable. Connections between the transport isolation room and the filtration system as well as the air hoses for the inflatable support structure in the preferred embodiment will be with flexible ducting and hoses allowing for easy placement of the filtration system and the air pump.

1. A medical isolation transport system comprising: a collapsible flexible liner, having top, floor and walls, sized and tailored to the interior of a medical emergency transport vehicle and adapted for rapid deployment as a medical isolation chamber in said interior of said medical emergency transport.

2. A medical isolation transport system according to claim 1, wherein said collapsible flexible liner permits both patient and medical personnel to be in said emergency transport vehicle, but isolated from the driver's cabin and/or other areas in the vehicle outside the flexible liner.

3. A medical isolation transport system according to claim 1, further comprising an air circulation system configured to create negative pressure in said medical isolation chamber, said air circulation system comprising a hepa or similar medical filtration system; and further comprising a support system sufficient to maintain said collabsible flexible liner in an erected state notwithstanding said negative pressure

4. In a preferred embodiment the tent like room has an integrated inflatable structure capable of rapid deployment, ease of use and strong enough to keep the tent walls from collapsing that are subject to the negative pressure created by the filter system, thus creating a contained working space for the patient and medical personnel during transport of an infected or contaminated patient.

5. In an alternate embodiment the structure required to maintain the tent like room within the vehicle can be made with mechanical components in lieu of an inflatable structure.

6. In an alternate embodiment the tent like room can be held with pre-installed attachment points within the vehicle in order to keep the room from collapsing or falling. Essentially the vehicle itself would modified and be used to support the tent like room.

7. A tent like room that essentially lines the medical area of a transport vehicle and is capable of containing bodily fluids, contaminants and infectious hazards from the outside environment and the vehicle itself.
